(19) United States
(12) Patent Application Publication
(10) Pub. No.: US 2013/0052376 A1
(43) Pub. Date: Feb. 28, 2013

(54) DEVICE HOUSING AND METHOD FOR MAKING THE DEVICE HOUSING

(71) Applicants: PO-FENG HO, Shindian (TW); XIN-WU GUAN, Shenzhen City (CN); CHAO-SHENG HUANG, Shenzhen City (CN)

(72) Inventors: PO-FENG HO, Shindian (TW); XIN-WU GUAN, Shenzhen City (CN); CHAO-SHENG HUANG, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/323,127

(22) Filed: Dec. 12, 2011

(30) Foreign Application Priority Data
Aug. 25, 2011 (CN) 201110246227.0

(51) Int. Cl. B32B 38/10; B32B 37/10; B32B 1/02; B32B 38/04

(52) U.S. Cl. 428/34.1; 156/257; 156/153

(57) ABSTRACT

A device housing for an electronic device is provided. The device housing includes a stainless steel substrate and at least one metal decorative member. The stainless steel substrate has at least one receiving recess defined in an outer surface and has a metallic coating formed on the outer surface. The at least one metal decorative member has a top surface. The top surface has a mirror finish. The at least one metal decorative member is received in the at least one receiving recess, with the top surface exposed out of the outer surface. The at least one metal decorative member forms a desired symbol, logo, or pattern on the device housing.

### BACKGROUND

1. Technical field

The present disclosure relates to device housings for electronic devices and a method for making the device housings with patterns or logos.

2. Description of related art

Shells for portable electronic devices are usually decorated with symbols, logos, or patterns to attract consumers. A typical method for making these decorations on a stainless steel shell includes the following steps: polishing, sandblasting, or hairline finishing the surface of a stainless steel substrate; then laser etching, chemical etching, or milling the surface to form a logo or symbol pattern. However, logos or symbols formed by such method usually are not sufficiently bright. Moreover, it is hard to polish by typical mechanical treatment.

Therefore, there is room for improvement within the art.

### BRIEF DESCRIPTION OF THE DRAWINGS

Many aspects of the present disclosure can be better understood with reference to the drawings. The components in the drawings are not necessarily drawn to scale, the emphasis instead being placed upon clearly illustrating the principles of the disclosure. Moreover, in the drawings like reference numerals designate corresponding parts throughout the views.

FIG. 1 is an exploded view of the present device housing according to an exemplary embodiment.

FIG. 2 is a schematic view of an assembled device housing according to an exemplary embodiment.

FIG. 3 is a cross-section view of the device housing show in FIG. 2 taken along line III-III.

FIG. 4 is a cross-section view of the present housing according to a second exemplary embodiment.

### DETAILED DESCRIPTION

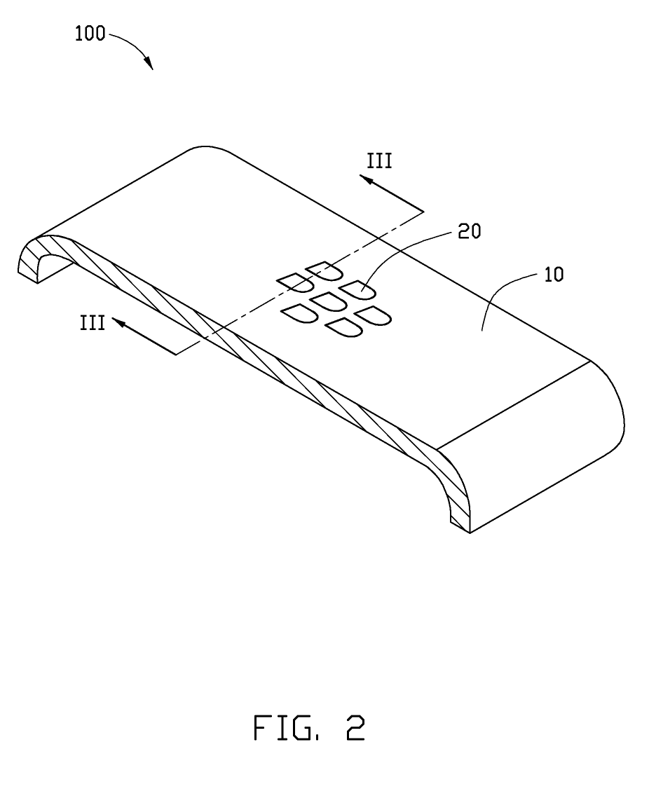

FIG. 2 shows an exemplary device housing 100 for electronic devices (such as mobile phones). In this exemplary embodiment, the device housing 100 is a cover of a mobile phone. The device housing 100 includes a main body 10 and at least one decorative member 20. In this embodiment, the device housing 100 includes a plurality of decorative members 20. As described in further detail below, the decorative members 20 are positioned within recesses of the main body 10 to form a desired symbol, logo, or pattern.

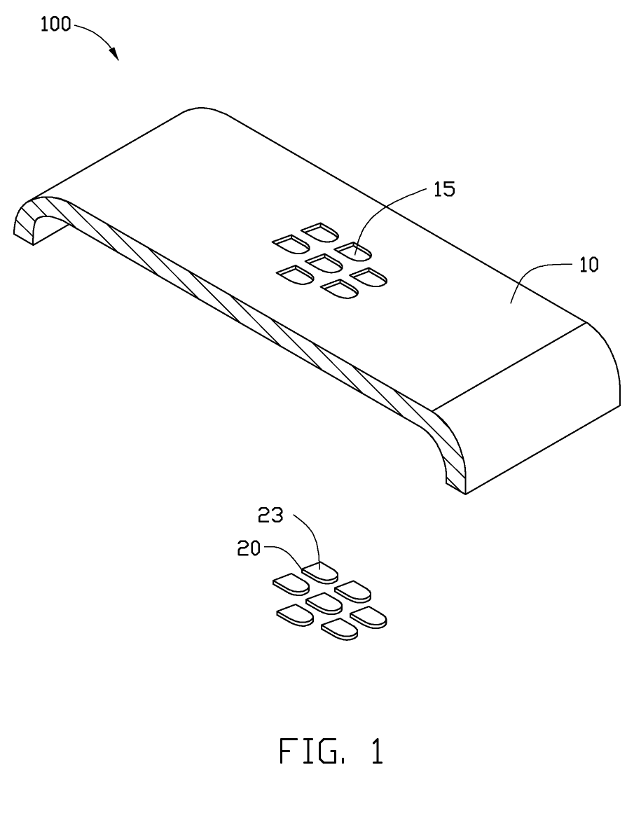

Referring to FIG. 1, the main body 10 includes a stainless steel substrate 11 having an inner surface 112 and an outer surface 114 opposite to the inner surface 112. The outer surface 114 defines at least one receiving recess 15 and has a metallic coating 16 formed thereon. In this embodiment, the outer surface 114 defines a plurality of recesses 15. The receiving recesses 15 depict a desired symbol, logo, or pattern on the outer surface 14. The receiving recesses 15 cooperate with each other to receive the decorative members 20. In this exemplary embodiment, each of the receiving recesses 15 has a depth of about 0.15 mm. The outer surface 114 may have a sandblasted pattern or a brushed texture of very fine lines, which may be the results of a sandblasting process or a hairline finishing process, the metallic coating 16 thereby has a surface profile corresponding to the outer surface 114. The metallic coating 16 may be made of one or more selected from the group consisting of oxide of metal, nitride of metal, carbide of metal, carbonitride of metal, and oxynitride of metal, which may be formed by physical vapor deposition (PVD). The metallic coating 16 has a metallic appearance and a desired color different from the decorative members 20. In this embodiment, the metallic coating 16 is made of nitride of metal formed by a PVD process.

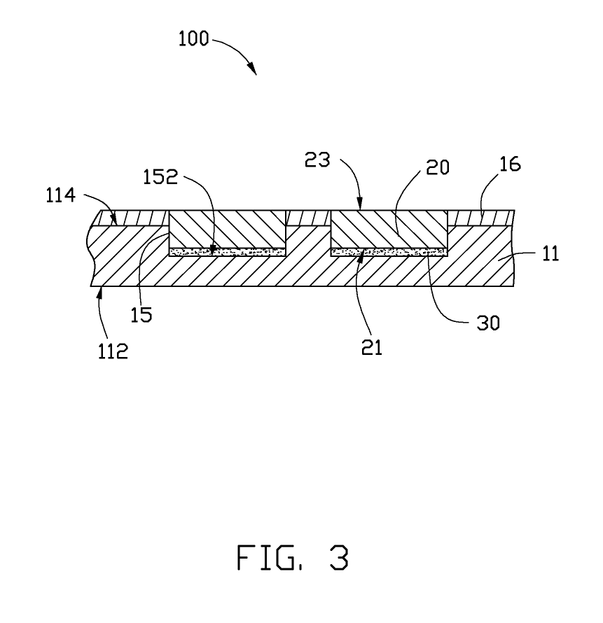

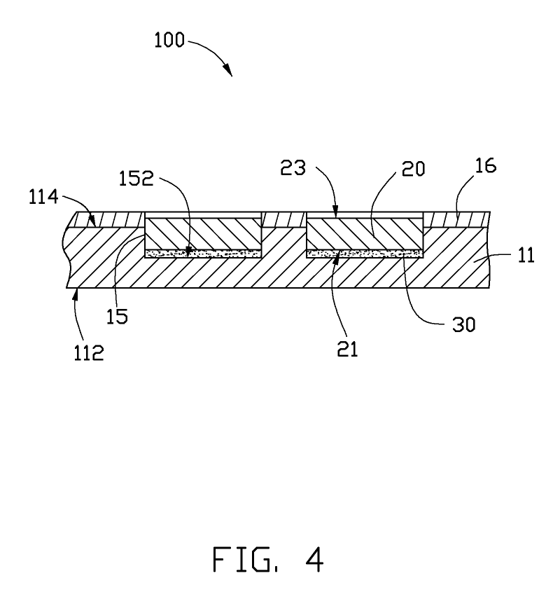

Referring to FIGS. 1 and 3, each decorative member 20 includes a bottom surface 21 and a top surface 23 opposite to the bottom surface 21. The top surface 23 may have a mirror finish and have a much higher gloss than the outer surface 14. Each decorative member 20 has a shape and size generally corresponding to the corresponding receiving recess 15, accordingly, the decorative members 20 can be received in the receiving recesses 15. The decorative members 20 are secured within the receiving recesses 15 by an adhesive layer 30, with the bottom surface 21 facing a bottom wall 152 of the receiving recesses 15 and the top surface 23 exposed out of the metallic coating 16. The top surface 23 of the decorative members 20 may be coplanar with the metallic coating 16. Alternatively, the top surface 23 may be lower than the metallic coating 16 of the main body 10 (see FIG. 4). In this exemplary embodiment, each of the decorative members 20 has a thickness of about 0.1 mm and the top surface 23 of the decorative members 20 is substantially coplanar with the metallic coating 16. The decorative members 20 are made of metal which can be polished to have a high gloss, such as stainless steel, titanium, titanium alloy, or aluminum alloy. In this exemplary embodiment, the decorative members 20 are made of stainless steel. The decorative members 20 can form a desired symbol, logo, or pattern on the device housing 100.

The adhesive layer 30 may be a heat-sensitive adhesive layer, such as a SP-7533 type heat-sensitive adhesive offered by 3M Ltd. The adhesive layer 30 is positioned between the decorative members 20 and the stainless steel substrate 11, securing the decorative members 20 within the corresponding receiving recesses 15.

An exemplary method for making the device housing 100 may include the following steps.

The stainless steel substrate 11 having the inner surface 112 and the outer surface 114 is provided. The stainless steel substrate 11 may be manufactured by stamping, for example.

The outer surface 114 may be polished to remove scratches received from the manufacturing process. This step may be omitted.

The receiving recesses 15 having the bottom wall 152 may be defined in the substrate 11 by laser engraving the outer surface 114. In this embodiment, the laser engraving process may be carried out under the following parameters: a frequency of about 40 KHz, a power of about 20 W, an engraving rate of about 1 mm/s.

The outer surface 114 is processed by sandblasting or hairline finishing, forming a sandblasted pattern or a brushed texture of very fine lines on the outer surface 114.

The outer surface 114 is processed by physical vapor deposition, forming the metallic coating 16 on the outer surface 114. The physical vapor deposition may be magnetron sputtering or arc ion plating.

The decorative members 20 having the bottom surface 21 and the high glossy top surface 23 are provided. The decorative members 20 may be manufactured by laser cutting a stainless steel sheet which has a mirror surface having a high gloss. In another embodiment, the decorative members 20 may be manufactured by die-cutting. In order to achieve a good match with the receiving recesses 15 which are formed by laser engraving, the decorative members 20 is preferably formed by laser cutting.

The adhesive layer 30 is formed on the bottom surface 21 of the decorative members 20 such as by printing.

The decorative members 20 with the adhesive layer 30 are placed into the receiving recesses 15, with the adhesive layer 30 contacting the bottom wall 152 of the receiving recesses 15.

Then, the decorative members 20 are heat-pressed at a temperature of about 65° C. to about 85° C., using a pressure of about 0.5 MPa for about 3 seconds to about 8 seconds. When cooled, the decorative members 20 are adhered in the receiving recesses 15 and form a desired symbol, logo, or pattern on the outer surface 114.

In order to protect the bottom walls 152 of the receiving recesses 15 from damage during the sandblasting process or hairline finishing process, masking material, such as ink may be filled in the receiving recesses 15 before sandblasting or hairline finishing the outer surface 114, and then removed before assembling the decorative members 20.

The top surface 23 of the decorative members 20 has a high glossiness, while the metallic coating 16 of the main body 10 has a surface profile corresponding to the outer surface 114. The outer surface 114 has a sandblasted pattern or a brushed texture of very fine lines, and thus the metallic coating 16 has a relative low gloss, allowing the symbol or logo formed by the decorative members 20 to have the desired contrasting appearance. Furthermore, the decorative members 20 are coplanar with or lower than the metallic coating 16 and are not easily subjected to abrasions. Moreover, the metallic coating 16 and the decorative members 20 have different colors, achieving a dual-color appearance on the device housing 100.

However, even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

1. A device housing, comprising:
a stainless steel substrate having an outer surface and an inner surface opposite to the outer surface, the outer surface defining at least one receiving recess and having a metallic coating formed, on regions of the outer surface adjacent the at least one receiving recess, the outer surface having a texture comprising fine lines, the metallic coating thereby having a surface profile corresponding to the outer surface; and
at least one metal decorative member, each of the at least one decorative member having a top surface and an opposite bottom surface, the top surface having a higher gloss than the outer surface, the at least one decorative member received in the corresponding at least one receiving recess, with the top surface visible by an observer.

2. (canceled)

3. The device housing as claimed in claim 1, wherein the metallic coating has a color different from that of the at least one decorative member.

4. The device housing as claimed in claim 1, wherein the metallic coating is made of one or more selected from the group consisting of oxide of metal, nitride of metal, carbide of metal, carbonitride of metal, and oxynitride of metal, which is formed by physical vapor deposition.

5. The device housing as claimed in claim 1, wherein the at least one decorative member is made of stainless steel.

6. The device housing as claimed in claim 1, wherein the at least one decorative member is secured within the at least one receiving recess by an adhesive layer located between the at least one decorative member and the stainless steel substrate.

7. The device housing as claimed in claim 6, wherein the adhesive layer is a heat-sensitive adhesive layer.

8. The device housing as claimed in claim 1, wherein the top surface of the at least one decorative member is coplanar with the metallic coating.

9. The device housing as claimed in claim 1, wherein the distance between the outer surface of the stainless steel substrate and the top surface of the at least one decorative member is less than the distance between the outer surface of the stainless steel substrate and an outer surface of the metallic coating.

10. The device housing as claimed in claim 1, wherein the at least one decorative member forms a symbol, logo, or pattern on the device housing.

11. A method for making a device housing, comprising:
providing a stainless steel substrate having an outer surface and an inner surface opposite to the outer surface;
defining at least one receiving recess in the outer surface by laser engraving, the at least one receiving recess having a bottom wall;
forming a metallic coating on the outer surface by physical vapor deposition;
providing at least one decorative member made of metal, the at least one decorative member having a top surface and an opposite bottom surface, the top surface having a mirror finish;
forming an adhesive layer on the bottom surface;
placing the at least one decorative member in the receiving recess, with the adhesive layer located between the at least one decorative member and the main body; and
heat pressing the at least one decorative member.

12. The method as claimed in claim 11, further comprising a step of sandblasting or hairline finishing the outer surface before the step of defining the at least one receiving recess.

13. The method as claimed in claim 12, further comprising a step of filling masking material in the receiving recesses before sandblasting or hairline finishing the outer surface.

14. The method as claimed in claim 11, wherein the heat pressing is carried out at a temperature of about 65° C.-85° C., using a pressure of about 0.5 Mpa for about 3 seconds to 8 seconds.

15. The method as claimed in claim 11, wherein the at least one decorative member is manufactured by laser cutting a stainless steel sheet having a mirror surface.

16. The method as claimed in claim 11, wherein the at least one decorative member is manufactured by die-cutting.
